(19) United States
(12) Patent Application Publication
(10) Pub. No.: US 2021/0009214 A1
(43) Pub. Date: Jan. 14, 2021

(54) Tracked Robot

(71) Applicant: Guangdong Instite of Intelligent Manufacturing, Guangzhou city (CN)

(72) Inventors: Xiaoming Jiang, Guangzhou city (CN); Xiaoguang Liu, Guangzhou city (CN); Lichao Cao, Guangzhou city (CN); Li Zhang, Guangzhou city (CN); Liang He, Guangzhou city (CN); Yong ZHOU, Guangzhou city (CN)

(73) Assignee: Guangdong Instite of Intelligent Manufacturing, Guangzhou city (CN)

(21) Appl. No.: 16/632,537

(22) PCT Filed: Jul. 25, 2018
(86) PCT No.: PCT/CN2018/097051

§ 371 Date: Jan. 21, 2020

(30) Foreign Application Priority Data
Jul. 31, 2017 (CN) 201720937162.7

(51) Int. Cl. B62D 55/06; B62D 55/30; B62D 55/14; B62D 55/125

(52) U.S. Cl. CPC B62D 55/06; B62D 55/30; B62D 55/075; B62D 55/125; B62D 55/14

(57) ABSTRACT

The tracked robot including a rack, two sets of track mechanisms and power components operating respectively in cooperation with the two sets of track mechanisms. Each set of track mechanism includes a track, a driving wheel, a tensioning wheel and a plurality of load bearing wheels, wherein the driving wheel, the tensioning wheel and the load bearing wheels are sleeved with the track, the tensioning wheel is used for tensioning the track, the driving wheel, the tensioning wheel and the load bearing wheels are rotatably arranged on the rack respectively through a driving wheel axle, a tensioning wheel axle and load bearing wheel axles, the driving wheel drives the tensioning wheel and the load bearing wheels to rotate through the track, baffles are arranged on the outer sides of the driving wheel, the tensioning wheel and the plurality of bearing wheels, and the track is embedded between the baffles.

### FIELD OF THE INVENTION

The present invention relates to the field of robots, in particular to a tracked robot.

### BACKGROUND OF THE INVENTION

Aloft work such as welding, detection, polishing and cleaning for large wall surfaces of large ships, oil tanks, nuclear power plants and the like are difficult in the current industrial field. Due to the smoothness and flatness of wall surfaces, manual operation is extremely difficult and low in efficiency, resulting in high surface operation costs and risks. Thus, a safe and reliable wall climbing robot is urgently needed for current engineering operation.

At present, only tracked attractive robots have high load capacity and are stable in operation, safe and reliable. However, the phenomenon of chain disengaging is prone to occurring when robots bear large lateral stress according to traditional chain-type tracked structures. For this reason, it is urgently necessary to develop a chain disengaging prevention tracked robot. In consideration of the above defects, the inventor of the present invention finally puts forwards the present invention after long-time study and practice.

### SUMMARY OF THE INVENTION

In order to solve the above-mentioned problems, the technical scheme adopted by the present invention is as follows. A tracked robot comprises a rack, two track mechanisms and power components operating respectively in cooperation with the two track mechanisms. Each track mechanism comprises a track, a driving wheel, a tensioning wheel and a plurality of load bearing wheels, wherein the driving wheel, the tensioning wheel and the load bearing wheels are sleeved with the track, the tensioning wheel is used for tensioning the track, the driving wheel, the tensioning wheel and the load bearing wheels are rotatably arranged on the rack respectively through a driving wheel axle, a tensioning wheel axle and load bearing wheel axles, and the driving wheel drives the tensioning wheel and the load bearing wheels to rotate through the track; and baffles are arranged on the outer sides of the driving wheel, the tensioning wheel and the multiple load bearing wheels, and the track is embedded between the baffles.

Furthermore, the driving wheels are provided with clamping grooves which are matched with shifting teeth in the tracks to drive the tracks to achieve transmission.

Furthermore, the bearing wheels on one sides of the tracks are provided with grooves, the grooves are matched with the shifting teeth inside the tracks to achieve transmission, and each tensioning wheel and each of other multiple load bearing wheels are respectively composed of two half side wheels.

Furthermore, the bearing wheels on the both sides of the tracks are provided with grooves, the grooves are matched with the shifting teeth inside the tracks to achieve transmission, and each tensioning wheel and each of other multiple load bearing wheels are respectively composed of two half side wheels.

Furthermore, each tensioning wheel and each of the multiple bearing wheels are respectively composed of two half side wheels.

Furthermore, the tracked robot comprises a buffering mechanism arranged on each tensioning wheel and used for providing a certain buffering space for the track corresponding to the tensioning wheel.

Furthermore, each buffering mechanism comprises a shock absorber and a tensioning wheel carrier, wherein the tensioning wheel carrier is fixed to the corresponding load bearing wheel axles, and the shock absorber is fixed between the corresponding tensioning wheel axle and the tensioning wheel carrier.

Compared with the prior art, the present invention has the following beneficial effects. First, the baffles are arranged on the outer sides of the driving wheels, the tensioning wheels and the load bearing wheels, the tracks are embedded between the baffles, and thus the baffles can limit the movement space of the tracks and prevent the tracks from derailing. Second, the grooves are formed in the load bearing wheels on both sides or one sides of the tracks and matched with the shifting teeth inside the tracks to achieve transmission, so that the load bearing wheels are prevented from slipping on the tracks. Third, the buffering mechanisms are arranged on the tensioning wheels and thus provide certain buffering spaces for the tracks corresponding to the tensioning wheels. Fourth, attractive components are arranged in the gaps between the convex platforms so that when the robot climbs on a wall surface, the attractive components can provide sufficient attraction pressure for the robot and also can reduce the collision between the robot and the wall surface, thereby making the robot walk more smoothly. Fifth, the surfaces of convex platforms are provided with patterns so that when the convex platforms are attached to the wall surface, the patterns on the surfaces of the convex platforms can further increase the friction coefficient between the tracks and the wall surface, thereby improving the friction force.

### BRIEF DESCRIPTION OF THE DRAWINGS

FIG. 1 is an overall structural view of a tracked robot of the present invention;

FIG. 2 is a partial structural view of a tracked robot of the present invention;

FIG. 3 is a structural view of a track of the present invention; and

FIG. 4 is a partial structural view of a tracked robot of the present invention.

### DESCRIPTION OF THE PREFERRED EMBODIMENTS

A more detailed description of the above and other technical characteristics and advantages of the present invention is given as follows in combination with the drawings.

### First Embodiment

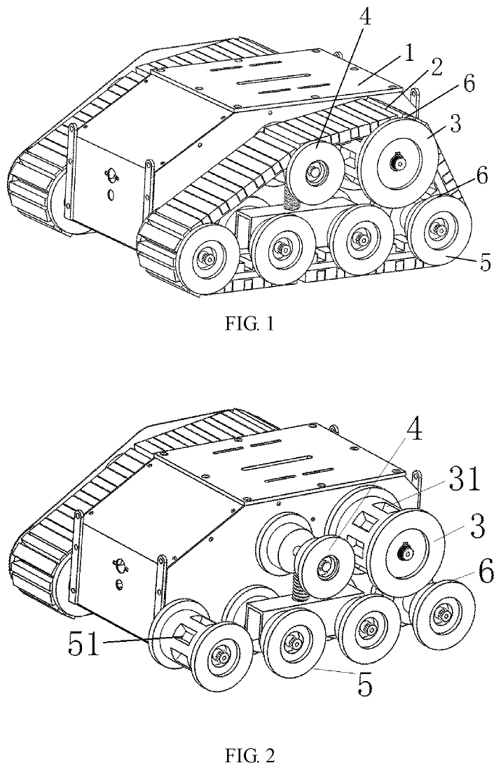

FIG. 1 is an overall structural view of a tracked robot of the present invention. As is shown in FIG. 1, a tracked robot comprises a rack 1, two track mechanisms and power components operating respectively in cooperation with the two track mechanisms. Each track mechanism comprises a track 2, a driving wheel 3, a tensioning wheel 4 and a plurality of load bearing wheels 5, wherein the driving wheel 3, the tensioning wheel 4 and the load bearing wheels 5 are sleeved with the track 2, the driving wheel 3, the tensioning wheel 4 and the load bearing wheels 5 are rotatably arranged on the track 1 respectively through a driving wheel axle, a tensioning wheel axle and load bearing wheel axles, the tensioning wheel 4 is used for tensioning the track 2, and the driving wheel 3 drives the tensioning wheel 4 and the load bearing wheels 5 to rotate through the track 2. Baffles are arranged on the outer sides of the driving wheels 3, the tensioning wheels 4 and the multiple load bearing wheels 5, the tracks 2 are embedded between the baffles 6, and thus the baffles 6 can limit the movement spaces of the tracks and prevent the tracks 2 from derailing.

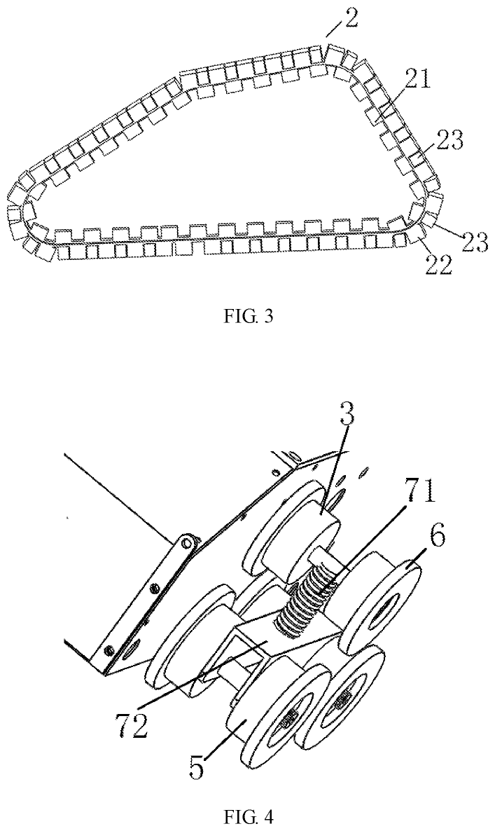

FIG. 2 is a partial structural view of the tracked robot of the present invention. FIG. 3 is a structural view of a track of the present invention. As is shown in FIG. 2 and FIG. 3, the driving wheels 3 are provided with clamping grooves 31, and the clamping grooves 31 are matched with shifting teeth 21 inside the tracks 2 to drive the tracks 2 to achieve transmission. The load bearing wheels 5 on one side of each track 2 are provided with clamping grooves 51. The clamping grooves 51 are matched with the shifting teeth 21 inside the tracks to achieve transmission. Other multiple load bearing wheels 5 are respectively composed of two half side wheels. The baffles on the outer sides of the driving wheels 3, the tensioning wheels 4 and the load bearing wheels 5 can limit the movement of the tracks. In this embodiment, the grooves 51 are formed in the load bearing wheels 5 on one sides of the tracks 2 and matched with the shifting teeth 21 inside the tracks to achieve transmission, so that the load bearing wheels 5 are prevented from slipping on the tracks.

The power components are motors or hydraulic cylinders and are fixedly arranged on the rack 1. The motors or the hydraulic cylinders are connected with the driving wheels 3 through output shafts of the motors or the hydraulic cylinders so as to provide power for the driving wheels 3. In this embodiment, the power components are motors and preferably servo motors, and batteries or other power supplies are adopted to supply power to the power components. In this embodiment, the two servo motors act on the driving wheels 3 in the two track structures respectively. Each servo motor can receive signals independently, and thus the robot can be controlled to advance, retreat or steer by controlling the servo motors to rotate forwards or reversely and controlling the rotating speed difference between the servo motors.

### Second Embodiment

As for the aforesaid tracked robot, the second embodiment is different from the above embodiment in that the driving wheels 3 are provided with clamping grooves 31 matched with shifting teeth 21 inside the tracks 2 to drive the tracks 2 to achieve transmission, the load bearing wheels 5 on both sides of each track 2 are provided with grooves 51 (grooves in the load bearing wheel 5 on one side are not shown in the figures), the grooves 51 are matched with the shifting teeth 21 inside the tracks to achieve transmission, each tensioning wheel 3 and each of other multiple load bearing wheels 5 are respectively composed of two half side wheels, and baffles on the outer sides of the driving wheels 3, the tensioning wheels 4 and the load bearing wheels 5 can limit the movement of the tracks.

In this embodiment, the bearing wheels 5 on both sides of each track 2 are provided with the corresponding grooves 51, and the grooves 51 are matched with the shifting teeth 21 inside the tracks to achieve transmission, so that the load bearing wheels 5 are prevented from slipping on the tracks.

### Third Embodiment

As for the aforesaid tracked robot, the third embodiment is different from the above embodiments in that the driving wheels 3 are provided with clamping grooves 31 matched with shifting teeth 21 inside the tracks 2 to drive the tracks 2 to achieve transmission, each tensioning wheel 4 and each load bearing wheel 5 are respectively composed of two half side wheels (each load bearing wheel is composed of two half side wheels not shown in the figures), and baffles 6 on the outer sides of the driving wheels 3, the tensioning wheels 4 and the load bearing wheels 5 can limit the movement of the tracks.

### Fourth Embodiment

As for the aforesaid tracked robot, the fourth embodiment is different from the above embodiments in that as is shown in FIG. 4 which is a partial structural view of the tracked robot of the present invention, the tracked robot further comprises a buffering mechanism arranged on each tensioning wheel 4 and used for providing a certain buffering space for the track 2 corresponding to the tensioning wheel 4.

Each buffering mechanism comprises a shock absorber 71 and a tensioning wheel carrier 72, wherein the tensioning wheel carrier 72 is fixed to the corresponding load bearing wheel axles, and the shock absorber 71 is fixed between the corresponding tensioning wheel axle and the tensioning wheel carrier 72. When the tracked robot vibrates in the operating process, the buffering mechanisms can achieve a buffering effect.

### Fifth Embodiment

As for the aforesaid tracked robot, the fifth embodiment is different from the above embodiments in that as is shown in FIG. 3, each track 2 is composed of a plurality of convex platforms 22. The convex platforms 22 make direct contact with a wall surface to improve the friction force.

Attractive components 23 are arranged in gaps between the convex platforms 22. When the robot climbs on the wall surface, the attractive components 23 can provide sufficient attraction pressure for the robot and also can reduce the collision between the robot and the wall surface, thereby making the robot walk more smoothly. Wherein, the attractive components are permanent magnets, electromagnetic suction cups or negative-pressure suction cups. In this embodiment, the attractive components 23 are preferably slightly lower than the convex platforms 22.

Furthermore, the surfaces of the convex platforms 22 are provided with patterns. Thus, when the convex platforms 22 are attached to the wall surface, the patterns on the surfaces of the convex platforms 22 can further increase the friction coefficient between the tracks 2 and the wall surface, thereby improving the friction force.

The embodiments mentioned above are only preferred embodiments of the present invention.

What should be pointed out is that for those ordinarily skilled in the field, various improvements and supplements can be made without deviating from the method of the present invention, and all these improvements and supplements also should fall within the protection scope of the present invention.

1. A tracked robot, comprising a rack, two sets of track mechanisms, and power components operating respectively in cooperation with the two sets of track mechanisms, characterized in that each set of track mechanism comprises a track, a driving wheel, a tensioning wheel and a plurality of load bearing wheels, wherein the driving wheel, the tensioning wheel and the load bearing wheels are sleeved with the track, the tensioning wheel is used for tensioning the track, the driving wheel, the tensioning wheel and the load bearing wheels are rotatably arranged on the rack through a driving wheel axle, a tensioning wheel axle and load bearing wheel axles respectively, the driving wheel drives the tensioning wheel and the load bearing wheels to rotate through the track, baffles are arranged on outer sides of the driving wheel, the tensioning wheel and the plurality of load bearing wheels, and the track is embedded between the baffles.

2. The tracked robot according to claim 1, characterized in that the driving wheels are provided with clamping grooves which are matched with shifting teeth inside the tracks to drive the tracks to achieve transmission.

3. The tracked robot according to claim 2, characterized in that the load bearing wheel on one side of the track is provided with a groove matched with the shifting teeth inside the track to achieve transmission, and the tensioning wheel and the other load bearing wheels are respectively composed of two half side wheels.

4. The tracked robot according to claim 2, characterized in that the load bearing wheels on both sides of the track are provided with grooves matched with the shifting teeth inside the track to achieve transmission, and the tensioning wheel and the other load bearing wheels are respectively composed of two half side wheels.

5. The tracked robot according to claim 2, characterized in that the tensioning wheel and the plurality of load bearing wheels are respectively composed of two half side wheels.

6. The tracked robot according to claim 1, characterized by further comprising a buffering mechanism arranged at the tensioning wheel and used for providing a certain buffering space for the track at the tensioning wheel.

7. The tracked robot according to claim 6, characterized in that the buffering mechanism comprises a shock absorber and a tensioning wheel carrier, wherein the tensioning wheel carrier is fixed on the load bearing wheel axles, and the shock absorber is fixed between the tensioning wheel axle and the tensioning wheel carrier.
